(19) United States
(12) Patent Application Publication
(10) Pub. No.: US 2025/0260757 A1
(43) Pub. Date: Aug. 14, 2025

(54) APPARATUS AND METHOD FOR PROVIDING PACKET HEADER HANDLING INFORMATION IN WIRELESS COMMUNICATION SYSTEM

(71) Applicant: ELECTRONICS AND TELECOMMUNICATIONS RESEARCH INSTITUTE, Daejeon (KR)

(72) Inventors: Seung Han CHOI, Daejeon (KR); Yoo Hwa KANG, Daejeon (KR); Namseok KO, Daejeon (KR)

(73) Assignee: ELECTRONICS AND TELECOMMUNICATIONS RESEARCH INSTITUTE, Daejeon (KR)

(21) Appl. No.: 19/050,251

(22) Filed: Feb. 11, 2025

(30) Foreign Application Priority Data
Feb. 13, 2024 (KR) 10-2024-0020231
Nov. 26, 2024 (KR) 10-2024-0170861

(51) Int. Cl. H04L 69/22

(52) U.S. Cl. CPC H04L 69/22

(57) ABSTRACT

Proposed are an apparatus and method for providing packet header handling information in wireless communication systems. The operation method for providing packet header handling information in a 5G system in a wireless communication system comprise registering, by a user plane function (UPF) having a packet header handling function, a packet header handling feature (PHHL) in a network repository function (NRF) through a service based interface (SBI), and searching, by a network function (NF), for the UPF containing the packet header handling Feature (PHHL) from the NRF through the SBI.

### CROSS REFERENCE TO RELATED APPLICATION

The present application claims priority to Korean Patent Application No. 10-2024-0020231, filed on Feb. 13, 2024, and Korean Patent Application No. 10-2024-0170861, filed on Nov. 26, 2024, the entire contents of which are incorporated herein for all purposes by this reference.

### BACKGROUND

### Technical Field

The present disclosure generally relates to wireless communication systems and, more specifically, relates to an apparatus and method for providing packet header handling information in wireless communication systems.

### Description of the Related Art

The 5G system provides a variety of network functions in order to support hyper-realistic, hyper-low latency, and hyper-reliable application services. Among them, a user plane function (UPF) plays an important role in the data processing layer. The UPF connects a radio access network (RAN) and a data network (DN) to perform functions such as packet routing, data forwarding, and quality of service (QOS) management and reporting. Through these functions, the 5G system increases data transmission efficiency and provides flexibility to respond to a user's various requirements.

However, the current 5G system lacks packet header handling functions optimized for specific application services, so there is a limit to providing specialized services to users by detecting or adding new packet headers. For example, subdivided packet control s required for services requiring hyper-low latency or user-tailored network slicing policies, but a systematic packet header handling function that supports this is not included in the current UPF structure.

In order to solve these problems, new functions are defined in the 3GPP Rel-16, 17, and 18 standards, but no specific method is proposed for detecting packet headers or adding new packet headers for packets forwarded in an uplink or downlink direction between an application function (AF) and the UPF. Accordingly, a system is required where the UPF registers packet header handling information in a network repository function (NRF), interacts with a session management function (SMF) and the AF through an interface, and processes new packet headers as needed.

### SUMMARY

The present disclosure based on the discussion above provides an apparatus and method which provides packet header handling information in wireless communication systems.

In addition, the present disclosure provides an apparatus and method which allow a user plane function (UPF) having a packet header handling function to register in a network repository function (NRF) in wireless communication systems.

In addition, the present disclosure provides an apparatus and method which allow a user plane function (UPF) having a packet header handling function to perform an association setup procedure with a session management function (SMF) in wireless communication systems.

In addition, the present disclosure provides an apparatus and method which allow an application function (AF) to provide packet header handling information to a UPF in wireless communication systems.

According to various exemplary embodiments of the present disclosure, an operation method for providing packet header handling information in a 5G system in a wireless communication system includes a process where a user plane function (UPF) having a packet header handling function registers a packet header handling feature (PHHL) in a network repository function (NRF) through a service based interface (SBI) and a process where a network function (NF) searches for the UPF containing the packet header handling Feature (PHHL) in the NRF through the SBI.

According to various exemplary embodiments of the present disclosure, an operation method for providing packet header handling information in a wireless communication system includes a process where a session management function (SMF) receives packet header handling information directly or via a network exposure function (NEF) from an application function (AF) through a policy control function (PCF) via a service based interface (SBI), a process where the SMF retransmits to a UPF the packet header handling information received from the PCF through an N4 interface, a process where the SMF receives the packet header handling information set through the N4 interface from the UPF and transmits the same directly or via the NEF to the AF through the PCF via the SBI, and a process where the UPF transmits the packet header handling information directly or via the NEF to the AF through the SBI.

According to various exemplary embodiments of the present disclosure, an apparatus for providing packet header handling information in a 5G system in a wireless communication system includes a communicator, and a controller operably connected to the communicator, wherein the controller allows a user plane function (UPF) having a packet header handling function to register a packet header handling feature (PHHL) in a network repository function (NRF) through a service based interface (SBI), and a network function (NF) to search for the UPF containing the packet header handling feature (PHHL) in the NRF through the SBI.

According to various exemplary embodiments of the present disclosure, an apparatus for providing packet header handling information in a wireless communication system includes a communicator and a controller operably connected to the communicator, wherein the controller allows a session management function (SMF) to receive packet header handling information directly or via a network exposure function (NEF) from an application function (AF) through a policy control function (PCF) via a service based interface (SBI), the SMF to retransmit the packet header handling information received from the PCF to a UPF through an N4 interface, the SMF to receive the packet header handling information set through the N4 interface from the UPF and transmits the same directly or via the NEF to the AF through the PCF via the SBI, and the UPF to transmit the packet header handling information directly or via the NEF to the AF through the SBI.

An apparatus and method according to various exemplary embodiments of the present disclosure can provide a network slicing policy, which is optimized and effective for application services, and a user-specific service, by providing packet header handling information to networks.

The effects obtained from the present disclosure are not limited to the effects mentioned above, and other effects not mentioned will be clearly understood by those skilled in the art to which the present disclosure pertains from the description below.

### BRIEF DESCRIPTION OF THE DRAWINGS

FIG. 1 is a view showing an example of an SBA-based wireless network architecture according to various exemplary embodiments of the present disclosure.

FIG. 2 is a view showing a signal flow diagram on a procedure for a UPF to register in an NRF according to various exemplary embodiments of the present disclosure.

FIG. 3 is a view showing a signal flow diagram on a procedure for an NF to search for a UPF in an NRF according to various exemplary embodiments of the present disclosure.

FIG. 4 is a view showing a signal flow diagram on a procedure of an association setup between an SMF and a UPF according to various exemplary embodiments of the present disclosure.

FIG. 5 is a view showing a signal flow diagram on a procedure where a UPF containing a packet header handling feature (PHHL) registers in an NRF according to an exemplary embodiment of the present disclosure.

FIG. 6 is a view showing a signal flow diagram on a procedure where an NF searches for a UPF containing a packet header handling feature (PHHL) in an NRF according to an exemplary embodiment of the present disclosure.

FIG. 7 is a view showing a signal flow diagram on a procedure where a UPF provides an UP function feature containing a packet header handling feature (PHHL) to an SMF in an association setup procedure between the SMF and the UPF according to an exemplary embodiment of the present disclosure.

FIG. 8 is a view showing a signal flow diagram on a procedure for an AF to provide packet header handling information to a UPF directly or via NEF and respond according to an exemplary embodiment of the present disclosure.

FIG. 9 is a view showing a configuration of a network entity in a wireless communication system according to various exemplary embodiments of the present disclosure.

### DETAILED DESCRIPTION OF THE DISCLOSURE

The terms used in the present disclosure may be used only to describe specific exemplary embodiments and may not be intended to limit the scope of other exemplary embodiments. Singular expressions may include plural expressions unless the context clearly indicates otherwise. Terms used herein, including technical or scientific terms, may have the same meaning as those generally understood by those of ordinary skill in the art described in the present disclosure. Among the terms used in the present disclosure, terms defined in a general dictionary may be interpreted in the same or similar meaning as the context of the related technology and may not be interpreted in an ideal or excessively formal meaning unless explicitly defined in the present disclosure. In some cases, even the terms defined in the present disclosure cannot be interpreted to exclude exemplary embodiments of the present disclosure.

In various exemplary embodiments of the present disclosure described below, a hardware approach will be described as an example. However, various exemplary embodiments of the present disclosure may include a technology using both hardware and software, so various exemplary embodiments of the present disclosure may not exclude a software-based approach.

In addition, in the detailed description and claim of the present disclosure, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

Hereinafter, the present disclosure may relate to an apparatus and a method for providing packet header handling information in a wireless communication system. Specifically, the present disclosure may describe a method and an apparatus where a user plane function (UPF) having a packet header handling function registers in a network repository function (NRF) in a wireless communication system, a method and an apparatus where a session management function (SMF) and a UPF having a packet header handling function perform an association setup procedure, and a method and an apparatus where an application function (AF) provides packet header handling information to a user plane function (UPF).

As used in the following description, terms referring to signals, terms referring to channels, terms referring to control information, terms referring to network entities, terms referring to components of the apparatus, and the like may be exemplified for convenience of description. Accordingly, the present disclosure may not be limited to terms described below, and other terms having equivalent technical meanings may be used.

In addition, the present disclosure may describe various exemplary embodiments by using terms used in some communication standards (e.g., 3GPP (3rd Generation Partnership Project)), but this is for illustrative purposes only. Various exemplary embodiments of the present disclosure can be easily modified and applied in other communication systems.

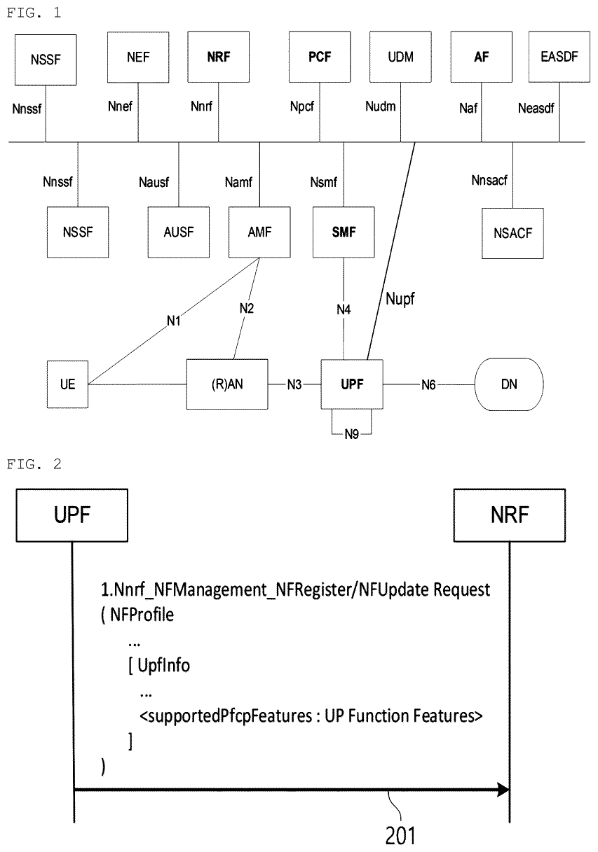

FIG. 1 is a view showing an example of an SBA-based wireless network architecture according to various exemplary embodiments of the present disclosure. Specifically, FIG. 1 is a view showing a 3GPP 5G system architecture of a service-based architecture applied to the present disclosure, which is currently being standardized in Rel-18.

Referring to FIG. 1, the network repository function (NRF) may support the registration and search of network functions, and each NF may play a role of registering itself and allowing for being searched by other NFs. A policy control function (PCF) may take charge of policy control functions and manage policies for optimizing service quality and network resources.

The session management function (SMF) may provide session management functions and manage packet processing, QOS settings, IP address allocation, and the like. The user plane function (UPF) may play the role of packet forwarding and routing, Qos processing, traffic management and the like in the data transport layer. An access and mobility management function (AMF) may provide mobility and access management functions and manage mobility between the terminal (UE: user equipment) and the 5G core network. A unified data management (UDM) may serve to store and manage user profiles and authentication data. A network slice selection function (NSSF) may take charge of the network slice selection function and may support traffic separation through network slicing. A network exposure function (NEF) may serve as an interface that supports to expose and control network functions to external applications. The application function (AF) may provide functions related to the applied service and may process requests related to packet processing and service in connection with the UPF.

Nnrf, Npcf, and Namf may be interfaces required for each function to communicate with each other and may be standard interfaces mainly used in a service-based architecture (SBA). A N4 interface may take charge of communication between the SMF and the UPF and may exchange information related to packet processing and QOS settings. The Nupf may be an interface that allows the UPF to be connected to other NFs through the service based interface (SBI) and may be mainly used for function extensions such as packet header handling. In addition to the conventional N4 interface, which is the interface with SMF, the UPF may be additionally connected to and included in the SBA through the service based interface (SBI) called the Nupf.

In the 3GPP 5G system architecture of FIG. 1, components of the network repository function (NRF) may be defined in order to provide a service search between an individual network function (NF). The NF may register its own service function in the NRF so that other NFs can search for the service function.

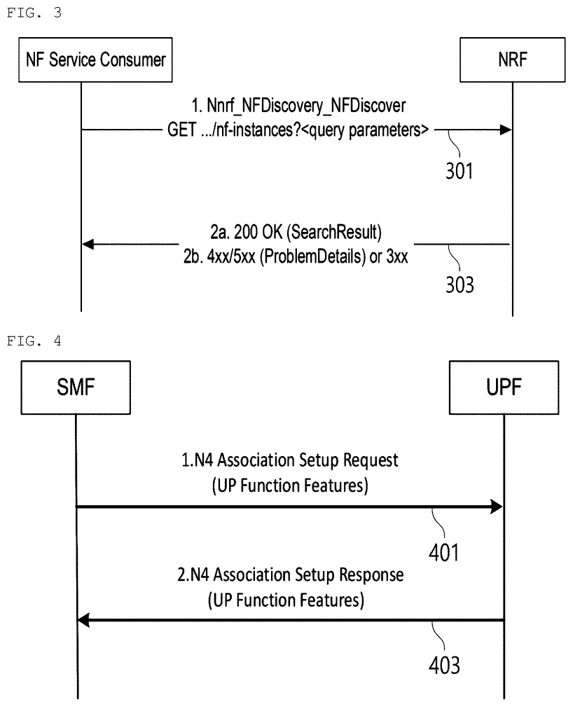

FIG. 2 is a view showing a signal flow diagram on a procedure for a UPF to register in an NRF according to various exemplary embodiments of the present disclosure. In detail, FIG. 2 illustrates a procedure for a UPF to register its own function in a network repository function (NRF).

Referring to FIG. 2, the UPF may transmit a message for putting and registering NFProfile of Table 1 and UpfInfo information of Table 2 in an operation of NFRegester or NFUpdate of Nnrf_NFManagement service (201). The supportPcpFeatures, which is an internal attribute of UpfInfo in Table 2, may refer to 3GPP TS 29.244 Table 8.2.25-1 UP Function Features in Table 3.

TABLE 1

| Attribute Name | Description |
|---|---|
| nfInstanceId | Unique identity of the NF Instance. |
| nfType | Type of Network Function |
| nfStatus | Status of the NF Instance (NOTE 5) (NOTE 16) |
| smfInfo | Specific data for the SMF (DNN's, . . . ). |
| upfInfo | Specific data for the UPF (S-NSSAI, DNN, |
| | SMF serving area, interface, |
| | supportedPfcoFeatures, . . . ) |
| . . . | . . . |

TABLE 2

| Attribute Name | Description |
|---|---|
| sNssaiUpfInfoList | List of parameters supported by the |
| | UPF per S-NSSAI (NOTE 1) |
| smfServingArea | The SMF service area (s) the UPF can |
| | serve. |
| | If not provided, the UPF can serve |
| | any SMF service area. |
| interfaceUpfInfoList | List of User Plane interfaces |
| | configured on the UPF. When this IE |
| | is provided in the NF Discovery |
| | response, the NF Service Consumer |
| | (e.g. SMF) may use this information |
| | for UPF selection. |
| | (NOTE 7) |
| supportedPfcpFeatures | Supported PFCP Features. |
| | A string used to indicate the PFCP |
| | features supported by the UPF, which |
| | encodes the “UP Function Features” |
| | IE as specified in Table 8.2.25-1 of |
| | 3GPP TS 29.244 [21] |
| . . . | . . . |

FIG. 3 is a view showing a signal flow diagram on a procedure for an NF to search for a UPF in an NRF according to various exemplary embodiments of the present disclosure. Specifically, FIG. 3 illustrates a procedure for another NF to search for a UPF having a specific function in an NRF.

Referring to FIG. 3, another NF may put query parameters for finding a UPF having a specific function in an NFDiscover operation of a Nnrf_NFDiscovery service and transmit the same in order to find the UPF having the specific function (301). According to an exemplary embodiment, the query parameters may be in the form of “NFT type=UPF and Upfinfo and supportedPfcpFeatures and BUCP=1 . . . ”.

The NRF may transmit the following response in response to the operation 301 (303).
(1) 200 OK (SearchResult) may be a response including a search result that the request has been successfully processed.
(2) 4xx/5xx (ProblemDetails) may be an error response including problem details when the request fails.
(3) 3xx may be a response indicating redirection.

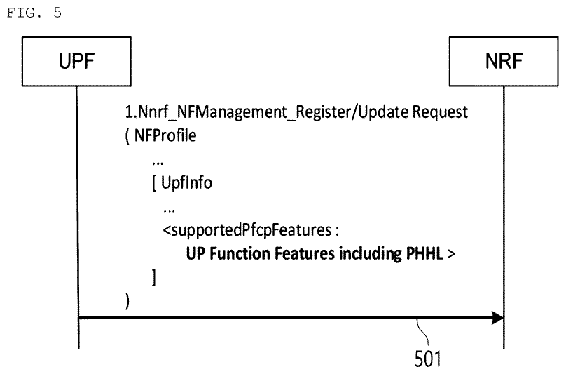

FIG. 4 is a view showing a signal flow diagram on a procedure of an association setup between an SMF and a UPF according to various exemplary embodiments of the present disclosure. In detail, FIG. 4 illustrates a procedure for an SMF and a UPF to establish an association connection in a situation where the SMF and the UPF are connected via the N4 interface.

Referring to FIG. 4, the SMF may put a parameter requesting an UP Function Feature from the UPF in a message of an N4 Association Setup Request and transmit the same in order to check the UP Function Features of the UPF (401).

The UPF may put the UP Function Features supported by the UPF in a message of an N4 Association Setup Response and transmit the same to the SMF (403).

Table 3 shows an event type (AfEvent) included when the AF requests a service to the PCF. Table 3 is disclosed in 3GPP TSs 29, 514.

TABLE 3

| Enumeration Value | Description |
|---|---|
| ACCESS_TYPE_CHANGE | Access type change. |
| ANI_REPORT | Access Network Information Report |
| | requested. |
| APP_DETECTION | Application detection report is |
| | requested. |
| CHARGING_CORRELATION | Access Network Charging Correlation |
| | Information. |
| UP_PATH_CHG_FAILURE | Indicates that the enforcement of |
| | the AF required routing |
| | requirements (i.e. DNAI change) |
| | failed. |
| L4S_SUPP | Indicates whether ECN marking for |
| | L4S is not available or available |
| | again in 5GS. |
| EPS_FALLBACK | Indicates the rejection of the |
| | establishment of the QoS flow for |
| | the requested voice media type in |
| | 5GS and the subsequent fallback to |
| | EPS. |
| . . . | . . . |

The UPF may perform the function of connecting the radio access network (RAN) and the data network (DN) as a network function included in the 3GPP 5G system. Specifically, functions such as packet routing and data forwarding, quality of service (QOS) management and reporting may be performed in the data processing layer. Currently, the demand for hyper-realistic, hyper-low latency, and hyper-reliable application services may be increasing in the wireless communication market, and there may be also a growing demand to expand services by applying new applications and transport layers to 5G systems.

To this end, it may be necessary to determine a network slicing policy optimized and effective for application services by detecting and analyzing packet headers of packets forwarded in uplink or downlink directions in the UPF. In addition, new packet headers for new service functions may be added to packets forwarded in uplink or downlink directions in the UPF so that a user-specific service can be provided.

There may be a problem in 3GPP Rel-16, 17, and 18 where there is no way to provide packet header handling information that enables the AF to request to detect and report packet headers in packets forwarded in uplink or downlink directions in the UPF, and to request the UPF to add new packet headers.

Therefore, in order to provide packet header handling information in a 5G system, the present disclosure may propose a method for a UPF having a packet header handling function to register in an NRF, a method for a UPF having a packet header handling function to perform an association setup procedure with an SMF, and a method and an apparatus to provide packet header handling information where an AF requests a UPF to detect a packet header of a packet forwarded in an uplink or downlink direction in the UPF or where the AF requests the UPF to add a new packet header.

Table 4 shows UP Function Features including packet header handling features for providing UP Function Feature information to the NRF or the SMF by the UPF of a 5G system according to an exemplary embodiment of the present disclosure.

TABLE 4

| Feature | Description |
|---|---|
| BUCP | Downlink Data Buffering in CP function is |
| | supported by the UP function. |
| DDND | The buffering parameter “Downlink Data |
| | Notification Delay” is supported by the UP |
| | function. |
| DLBD | The buffering parameter “DL Buffering Duration” in |
| | PFCP Session Report Response is supported by the |
| | UP function. |
| TRST | Traffic Steering is supported by the UP function. |
| FTUP | F-TEID allocation/release in the UP function is |
| | supported by the UP function. |
| PFDM | The PFD Management procedure is supported by the |
| | UP function. |
| HEEU | Header Enrichment of Uplink traffic is supported |
| | by the UP function. |
| TREU | Traffic Redirection Enforcement in the UP function |
| | is supported by the UP function. |
| . . . | . . . |
| PHHL | Packet Header Handling in the UP function is |
| | supported by the UP function. |

Referring to Table 4, the BUCP may be that the Downlink Data Buffering in the CP (control plane) function is supported by the UP function. The DDND may support the buffering parameter “downlink data notification delay” in the UP function. The DLBD may support the buffering parameter “DL Buffering Duration” of PFCP Session Report Response in the UP function. The TRST may be that traffic steering is supported by the UP function. The FTUP may be that F-TEID allocation/release is supported in the UP function. The PFDM may be that the PFD Management procedure is supported in the UP function. The HEEU may be that header enrichment of uplink traffic is supported in the UP function. The TREU may be that traffic redirection enforcement is supported in the UP function. The PHHL may be that packet header handling is supported in the UP function.

Tables 5 and 6 illustrate packet header handling information that an AF of a 5G system transmits to a UPF according to an exemplary embodiment of the present disclosure. Specifically, Table 5 relates to packet header handling request information, and Table 6 relates to packet header handling response information.

TABLE 5

| Attribute 1 | Value | Description | Attribute 2 | Value | Description |
|---|---|---|---|---|---|
| Command Type | Request | Command type | | | |
| Transaction | | Transaction ID | | | |
| Identifier | | | | | |
| Direction | Downlink or | Packet header | | | |
| | Uplink | handling | | | |
| | | processing | | | |
| | | direction | | | |
| Session Type | S-NSSAI/DNN, | Session type | Session | | Session ID |
| | FQDN, PDU | | Identifier | | |
| | Session, | | | | |
| | Traffic | | | | |
| | Flows, | | | | |
| | Subscriber, | | | | |
| | DNAI, etc. | | | | |
| Packet Header | Detecting | Packet header | Packet Header | Ethernet, | Packet header |
| Handling | Header | handling | Type | MPLS, SRv6, | protocol type |
| Operation Type | Report | operation type | | IPv4, IPv6, | to detect |
| | | Packet header | | TCP, UDP, | |
| | | detection | | HTTP, RTP, | |
| | | report | | RTCP, . . . | |
| | Inserting | Packet header | Packet Header | | Added packet |
| | Header | handling | Type | | header |
| | Report | operation type | | | protocol type |
| | | Reporting the | | | |
| | | state of added | | | |
| | | packet header | | | |
| | Inserting | Packet header | Packet Header | | Packet header |
| | Header | handling | Type | | protocol type |
| | | operation type | | | |
| | | Adding packet | | | |
| | | header | | | |
| | | | Packet Header | | Packet header |
| | | | Field Name 1 | | field name to |
| | | | | | add |
| | | | Packet Header | | |
| | | | Field Name 2 | | |
| | | | . . . | | |
| | | | Packet Header | | |
| | | | Field Name N | | |
| Packet Header | only once, | Packet header | | | |
| Handling | all packets | handle | | | |
| Period | in the | processing | | | |
| | applied | period | | | |
| | configuration, | | | | |
| | upon | | | | |
| | changes of | | | | |
| | traffic | | | | |
| | destination, | | | | |
| | etc. | | | | |
| Authentication | Authentication | Authentication | Authentication | Authentication | Decryption |
| | Type | Type | Key | Key | key for |
| | | | | | detection/ |
| | | | | | insertion |
| | | | | | of encrypted |
| | | | | | packets |

Referring to Table 5, the Command Type may indicate the command type, and an example thereof may be “Request”. The Transaction Identifier may be a transaction ID, which can provide a unique identifier for a session. The Direction may be a packet header processing direction, which can indicate a “Downlink” or “Uplink” direction. The Session Type may indicate a session type, and may include S-NSSAI/DNN, FQDN, PDU session, traffic flow, subscriber ID, DNAI, and the like. The Session Identifier may be a session ID, which can be used to identify a specific session.

The Packet Header Handling Operation Type may include Detecting Header Report, Inserting Header Report, and Inserting Header. The Detecting Header Report may be a type of detecting and reporting packet headers, which can specify a packet header protocol type (e.g., Ethernet, MPLS, SRv6, IPV4, IPV6, TCP, UDP, HTTP, RTP, RTCP, etc.) to be detected. The Inserting Header Report may be a type of reporting a state where a packet header is added. The Inserting Header may be a type of adding a packet header, which can specify a packet header field name to be added.

The Packet Header Handling Period may specify a specific packet header handling period, and may have options such as “only once”, “applying to all packets”, “applying when changing traffic destinations” and the like.

The Authentication may include Authentication Type and Authentication Key. The Authentication Type may specify an authentication type. The Authentication Key may be an authentication key, which can be the key used when detecting or inserting an encrypted packet.

TABLE 6

| Attribute 1 | Value | Description | Attribute 2 | Value | Description |
|---|---|---|---|---|---|
| Command | Response | Command Type | | | |
| Type | | | | | |
| Transaction | | Transaction ID | | | |
| Identifier | | | | | |
| Direction | Downlink or | Packet header | | | |
| | Uplink | handling | | | |
| | | processing | | | |
| | | direction | | | |
| Session | S-NSSAI/DNN, | Session Type | Session | | Session ID |
| Type | FQDN, PDU | | Identifier | | |
| | Session, | | | | |
| | Traffic | | | | |
| | Flows, | | | | |
| | Subscriber, | | | | |
| | DNAI, etc. | | | | |
| Packet | Detecting | Packet header | Packet Header | Ethernet, | Detected |
| Header | Header | handling | Type | MPLS, | packet header |
| Handling | Report | operation type | | SRv6, | protocol type |
| Operation | | Packet header | | IPv4, | |
| Type | | detection | | IPv6, TCP, | |
| | | report | | UDP, HTTP, | |
| | | | | RTP, RTCP, | |
| | | | | etc. | |
| | | | Packet Header | | Detected |
| | | | Field Name 1 | | packet header |
| | | | | | field name |
| | | | Packet Header | | |
| | | | Field Name 2 | | |
| | | | . . . | | |
| | | | Packet Header | | |
| | | | Field Name N | | |
| | Inserting | Packet header | Packet Header | | Added packet |
| | Header | handling | Type | | header |
| | Report | operation type | | | protocol type |
| | | Reporting the | | | |
| | | state of added | | | |
| | | packet header | | | |
| | | | Packet Header | | Added packet |
| | | | Field Name 1 | | header field |
| | | | | | name |
| | | | Packet Header | | |
| | | | Field Name 2 | | |
| | | | . . . | | |
| | | | Packet Header | | |
| | | | Field Name N | | |
| | Inserting | Packet header | Packet Header | | Added packet |
| | Header | handling | Type | | header |
| | | operation type | | | protocol type |
| | | Adding packet | | | |
| | | header | | | |
| | | | Packet Header | | Added packet |
| | | | Field Name 1 | | header field |
| | | | | | name |
| | | | Packet Header | | |
| | | | Field Name 2 | | |
| | | | . . . | | |
| | | | Packet Header | | |
| | | | Field Name N | | |
| Packet | only once, | Packet header | | | |
| Header | all packets | handle | | | |
| Handling | in the | processing | | | |
| Period | applied | period | | | |
| | configuration, | | | | |
| | upon | | | | |
| | changes of | | | | |
| | traffic | | | | |
| | destination, | | | | |
| | etc. | | | | |

Referring to Table 6, the Command Type may be a request type, and a command type may be specified as “Response”. The Transaction Identifier may be a transaction ID for each request, which can be used to uniquely identify a session. The Direction may specify a processing direction of packets, which can be set as “Downlink” or “Uplink”. The Session Type may refer to a session type, which can include S-NSSAI/DN, FQDN, PDU session, traffic flow, subscribers, DNAIs, and the like. The Session Identifier may be a session ID uniquely identifying a session.

The Packet Header Handling Operation Type may include Detecting Header Report, Inserting Header Report, and Inserting Header. The Detecting Header Report may be an operation type of detecting and reporting a packet header, which can specify a header protocol type (e.g., Ethernet, MPLS, SRv6, IPV4, IPV6, TCP, UDP, HTTP, RTP, RTCP, etc.) to be detected. The Inserting Header Report may be an operation type of reporting a state of an added packet header. The Inserting Header may be an operation type of inserting a packet header, which can specify a field name to be inserted.

The Packet Header Fields may include the Packet Header Field Name. The Packet Header Field Name may specify the name of the field to be detected or inserted, which can list several field names sequentially (e.g., Name 1, Name 2, etc.).

The Packet Header Handling Period may include Handling Period. The Handling Period may specify a period to which a particular packet header handling is applied. Examples may include “only once”, “lasting in all of the applied packets (all packets in the applied configuration)”, and “upon changes of traffic destination”, and the like.

The Authentication may include Authentication Type and Authentication Key. The Authentication Type may be an authentication method. The Authentication Key may be an authentication key, which can be used as a decryption key required when detecting or inserting an encrypted packet.

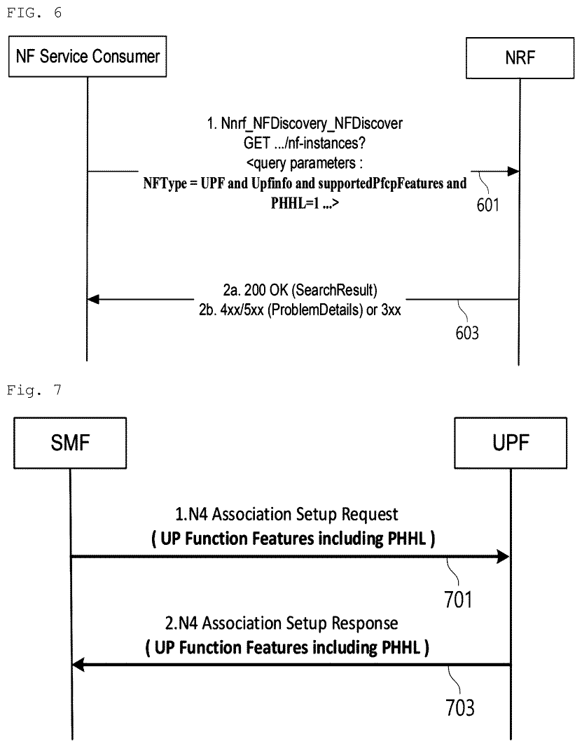

FIG. 5 is a view showing a signal flow diagram on a procedure where a UPF containing a packet header handling feature (PHHL) registers in an NRF according to an exemplary embodiment of the present disclosure.

Referring to FIG. 5, the UPF may transmit a message of an Nnrf_NFManagement_Register or Update Request to the NRF in order to register or update its own NFProfile (501). The NFProfile may include UpfInfo, and detailed information of the UP function may be included in the supportedPfcpFeature field.

According to an exemplary embodiment, the supportedPfcpFeatures field may include a list of functions supported by the UPF, and the UP function features containing Packet Header Handling (PHHL) may be specified.

That is, the process of FIG. 5 may be a process in which the UPF registers a specific function supported by itself, particularly, a PHHL function, in the NRF and other network functions (NF) can search for and use the same when necessary. Accordingly, the function of the UPF may be efficiently utilized in the 5G network.

FIG. 6 is a view showing a signal flow diagram on a procedure where an NF searches for a UPF containing a packet header handling feature (PHHL) in an NRF according to an exemplary embodiment of the present disclosure.

Referring to FIG. 6, the NF Service Consumer may transmit a Nnrf_NFDiscovery_NFDiscover request to the NRF and search for an NF instance that satisfies a specific condition (701).

The Nnrf_NFDiscovery_NFDiscover request may be made in the form of GET . . . /nf-instances, and the request described above may include the following query parameters.
(1) NFTtype=UPF: parameters for finding network functions of UPF types.
(2) UpfInfo and supportedPfcpFeatures: information specifying UPF functions.
(3) PHHL=1: indicating whether the UPF supports Packet Header Handling (PHHL).

The NRF may transmit a response according to the request of the operation 701 (703). The response of the operation 703 may include 200 OK (SearchResult), and 4xx/5xx (ProblemDetails).

The 200 OK (SearchResult) may be a response where the request is successfully processed and where the search result is included.

4xx/5xx (ProblemDetails) may be a response that contains details of the problem when an error occurs.

3xx may be a redirection response.

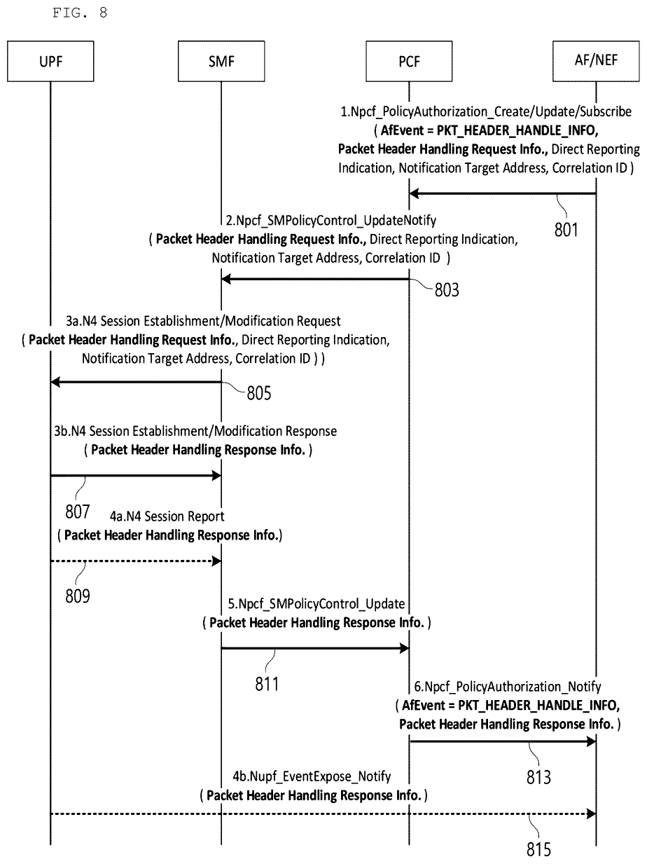

FIG. 7 is a view showing a signal flow diagram on a procedure where a UPF provides an UP function feature containing a packet header handling feature (PHHL) to a SMF in an association setup procedure between the SMF and the UPF according to an exemplary embodiment of the present disclosure.

Referring to FIG. 7, the SMF may transmit a message of an N4 Association Setup Request to the UPF (701). The request message of the operation 701 may include features of the UP function, and may specify a Packet Header Handling (PHHL) function. The operation 701 may be a procedure for checking and requesting whether the UPF supports the PHHL function.

The UPF may respond to the request of the operation 701 through the message of N4 Association Setup Response (703). The response message of the operation 703 may include the UP Function Features including the PHHL, which may indicate that the UPF supports the PHHL function.

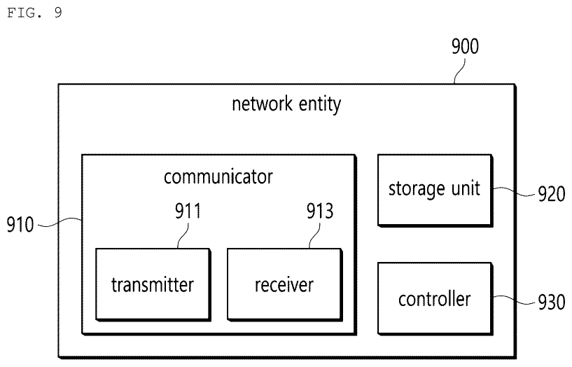

FIG. 8 is a view showing a signal flow diagram on a procedure for an AF to provide packet header handling information to a UPF directly or via NEF and respond according to an exemplary embodiment of the present disclosure.

Referring to FIG. 8, the AF or the NEF may transmit a PolicyAuthorization request to the PCF (801). The operation 801 may request a including packet header handling PKT_HEADER_HANDLE_INFO as an event. The packet header handling request may include at least one of Direct Reporting Indication, Notification Target Address, and Correlation ID.

The PCF may transmit an SMP PolicyControl update notification to the SMF (803). In the operation 703, at least one of Packet Header Handling Request Info, Direct Reporting Indication, Notification Target Address, or information related to Correction ID may be transmitted.

The SMF may transmit an N4 session setup or modification request to the UPF (805). The N4 session setup or modification request may include at least one of Packet Header Handling Request Info, Direct Reporting Indication, Notification Target Address, or information related to Correlation ID.

The UPF may transmit a response to the session setup or modification request to the SMF (807). The response of the operation 707 may include Packet Header Handling Response Info.

When necessary, the UPF may perform an N4 session report to the SMF (809). The N4 session report may include Packet Header Handling Response Info.

The SMF may transmit a SMP PolicyControl update request to the PCF (811). In the operation 711, the Packet Header Handling Response Info may be transmitted.

The PCF may transmit a PolicyAuthorization notification to the AF or the NEF (813). The notification of the operation 713 may include PKT_HEADER_HANDLE_INFO and Packet Header Handling Response Info as events.

When necessary, the UPF may notify a Packet Header Handling Response Info through an EventExpose_Notify (815).

FIG. 9 is a view showing a configuration of a network entity in a wireless communication system according to various exemplary embodiments of the present disclosure. A network entity of the present disclosure may be a concept including a network function according to a system implementation. The terms such as “˜ unit”, “˜ device”, and the like used hereinafter may refer to a unit that processes at least one function or operation, and this can be implemented by hardware or software, or a combination of hardware and software.

The network entity 900 according to various exemplary embodiments of the present disclosure may include a communicator 910, a storage unit 920, and a controller 930 for controlling an overall operation of the network entity 900. The communicator 910 may transmit and receive signals with other network entities. Accordingly, all or a part of the communicator 910 may be referred to as a “transmitter 911”, a “receiver 913”, or a “transceiver 910”. The storage unit 920 may store data such as basic programs, application programs, setting information, and the like for the operation of the network entity 900. The storage unit 920 may be configured as a volatile memory, a nonvolatile memory, or a combination of a volatile memory and a nonvolatile memory. Also, the storage unit 920 may provide stored data according to the request of the controller 930. The controller 930 may control the overall operations of the network entity 900. For example, the controller 930 may transmit and receive signals through the communicator 910. In addition, the controller 930 may record and read data in the storage unit 920. Also, the controller 930 may perform functions of a protocol stack required by a communication standard. To this end, the controller 930 may include a circuit, an application-specific circuit, at least one processor, or microprocessor, or may be a part of a processor. In addition, a part of the communicator 910 and the controller 930 may be referred to as a communication processor (CP). The controller 930 may control the network entity 900 in order to perform an operation of any one of various exemplary embodiments of the present disclosure. The communicator 910 and the controller 930 may not be necessarily implemented as separate modules, but may be implemented as a single component in the form of a single chip or a software block. The communicator 910, the storage unit 920, and the controller 930 may be electrically connected to each other. In addition, the operations of the network entity 900 may be realized by providing the storage unit 920 storing the corresponding program codes within the network entity 900. The network entity 900 may include a network node, and may be any one of NSSF, NRF, EASDF, NSACF, UE, DN, base station (RAN), AMF, SMF, UPF, NE, NEF, NRF, CF, NSSF, UDM, AF, AUSF, SCP, UDSF, context storage, OAM, EMS, configuration server, and ID (identifier) management server shown in FIG. 1.

Methods according to exemplary embodiments described in the claims or specification of the present disclosure may be implemented in the form of hardware, software, or a combination of hardware and software.

When implemented in software, a computer-readable storage medium for storing one or more programs (software modules) may be provided. One or more programs stored in the computer-readable storage medium may be configured to be executable by one or more processors in an electronic device. One or more programs may contain instructions that enable the electronic device to execute methods according to exemplary embodiments described in the claims or specification of the present disclosure.

These programs (software modules, software) may be stored in a random access memory, a non-volatile memory including a flash memory, a read only memory (ROM), an electrically erasable programmable read only memory (EEPROM), a magnetic disc storage device, a compact disc-ROM (CD-ROM), digital versatile discs (DVDs), other forms of optical storage devices, or a magnetic cassette. Alternatively, they may be stored in a memory composed of a combination of some or all of these. In addition, each component memory may be included in a plurality.

In addition, programs may be stored in an attachable storage device that is accessible via a communication network such as the Internet, an intranet, a local area network (LAN), a wide area network (WAN), or a storage area network (SAN), or a combination thereof. Such a storage device may access a device performing an exemplary embodiment of the present disclosure through an external port. In addition, a separate storage device on a communication network may access a device performing an exemplary embodiment of the present disclosure.

In specific exemplary embodiments of the present disclosure described above, components included in the disclosure may be expressed in singular or plural according to the presented specific exemplary embodiment. However, singular or plural expressions may be selected appropriately for the presented situation for the convenience of explanation, and the present disclosure may not be limited to singular or plural components, and even when the components are expressed in the plural, they may be configured in the singular or even when the component is expressed in the singular, they may be configured as the plural.

Meanwhile, in the detailed description of the present disclosure, specific exemplary embodiments are described, but various modifications may be possible without departing from the scope of the present disclosure. Therefore, the scope of the present disclosure should not be limited to the described exemplary embodiments, but should be determined not only by the scope of the patent claim described later, but also by those equivalent to the scope of the patent claim.

What is claimed is:

1. An operation method for providing packet header handling information in a 5G system in a wireless communication system, the method comprising:
registering, by a user plane function (UPF) having a packet header handling function, a packet header handling feature (PHHL) in a network repository function (NRF) through a service based interface (SBI); and
searching, by a network function (NF), for the UPF containing the packet header handling feature (PHHL) in the NRF through the SBI.

2. The method of claim 1, wherein the SBI used when the UPF having the packet header handling function registers the packet header handling feature (PHHL) in the NRF is at least one of a Nnrf_NFManagement_Register Request, or a Nnrf_NFManagement_Update Request service,
where at least one of the Nnrf_NFManagement_Register Request, or the Nnrf_NFManagement_Update Request service is composed of supportedPfcpFeatures,
and the supportedPfcpFeatures is composed of the packet header handling feature (PHHL).

3. The method of claim 1, wherein the SBI used when the network function (NF) searches for the UPF containing the packet header handling feature (PHHL) in the NRF through the SBI is a Nnrf_NFDiscovery_NFDiscover service,
wherein the Nnrf_NFDiscovery_NFDiscover service is composed of query parameters, and the query parameters are composed of the packet header handling feature (PHHL) which is an UP function feature.

4. An operation method for providing packet header handling information in a wireless communication system, the method comprising:
receiving, by a session management function (SMF), packet header handling information directly or via a network exposure function (NEF) from an application function (AF) through a policy control function (PCF) via a service based interface (SBI);
retransmitting, by the SMF to a UPF, the packet header handling information received from the PCF through an N4 interface;
receiving, by the SMF, the packet header handling information set through the N4 interface from the UPF and transmits the same directly or via the NEF to the AF through the PCF via the SBI; and
transmitting, by the UPF, the packet header handling information directly or via the NEF to the AF through the SBI.

5. The method of claim 4, wherein the SBI used when the SMF transmits and receives the packet header handling information directly or via the NEF to and from the AF is a Npcf_PolicyAuthorization, or a Npcf_SMPolicyControl.

6. The method of claim 5, wherein the Npcf_PolicyAuthorization service operation, which is the SBI for transmitting and receiving the packet header handling information between the AF and the PCF, is composed of information indicating the packet header handling information.

7. The method of claim 5, wherein a protocol for exchanging the packet header handling information between the SMF and the UPF is at least one of N4 PFCP (packet forward control protocol), N4 Session Establishment, N4 Session Modification, or N4 Session Report messages.

8. The method of claim 5, wherein an operation where the UPF transmits the packet header handling information directly or via the NEF to the AF through the SBI is a Nupf_EventExposure_Notify service operation.

9. The method of claim 5, wherein the packet header handling information between the AF and the UPF is composed of at least one of a Command Type, a Transaction Identifier, a Direction, a Session Type, a Session Identifier, a Packet Header Handling Operation Type, a Packet Header Handling Period, a Authentication, a Packet Header Type, or a Packet Header Field Name,
wherein the Command Type is composed of a Request or a Response,
the Direction is composed of a Uplink or a Downlink,
and the Packet Header Handling Operation Type is composed of at least one of a Detection Header Report, an Inserting Header Report, or an Inserting Header.

10. The method of claim 5, wherein the packet header handling function is that the UPF is composed of at least one of a packet header addition, a packet header detection, a packet header addition report, or a packet header detection report according to a request of the AF.

11. An apparatus for providing packet header handling information in a 5G system in a wireless communication system, the apparatus comprising:
a communicator; and
a controller operably connected to the communicator,
wherein the controller is configured to:
control a user plane function (UPF) having a packet header handling function to register a packet header handling feature (PHHL) in a network repository function (NRF) through a service based interface (SBI), and
control a network function (NF) to search for the UPF containing the packet header handling feature (PHHL) in the NRF through the SBI.

12. The apparatus of claim 11, wherein the SBI used when the UPF having the packet header handling function registers the packet header handling feature (PHHL) in the NRF is at least one of a Nnrf_NFManagement_Register Request, or a Nnrf_NFManagement_Update Request service,
where at least one of the Nnrf_NFManagement_Register Request, or the Nnrf_NFManagement_Update Request service is composed of supportedPfcpFeatures,
and the supportedPfcpFeatures is composed of the packet header handling feature (PHHL).

13. The apparatus of claim 11, wherein the SBI used when the network function (NF) searches for the UPF containing the packet header handling feature (PHHL) in the NRF through the SBI is a Nnrf_NFDiscovery_NFDiscover service,
wherein the Nnrf_NFDiscovery_NFDiscover service is composed of query parameters, and the query parameters are composed of the packet header handling feature (PHHL) which is an UP function feature.
